(19) United States
(12) Patent Application Publication
(10) Pub. No.: US 2013/0044147 A1
(43) Pub. Date: Feb. 21, 2013

(54) THREE-DIMENSIONAL IMAGE DISPLAY APPARATUS AND METHOD OF DRIVING THE SAME

(71) Applicants: Sang-Jae KIM, Seongnam-si (KR); Kwang-Hyun KIM, Gunpo-si (KR); Ji-Hoon KIM, Hwaseong-si (KR); Seungbeom PARK, Seoul (KR); Beong-hun BEON, Cheonan-si (KR); Seunghee LEE, Seoul (KR)

(72) Inventors: Sang-Jae KIM, Seongnam-si (KR); Kwang-Hyun KIM, Gunpo-si (KR); Ji-Hoon KIM, Hwaseong-si (KR); Seungbeom PARK, Seoul (KR); Beong-hun BEON, Cheonan-si (KR); Seunghee LEE, Seoul (KR)

(73) Assignee: SAMSUNG ELECTRONICS CO., LTD., Suwon-si (KR)

(21) Appl. No.: 13/442,211

(22) Filed: Apr. 9, 2012

(30) Foreign Application Priority Data
Aug. 19, 2011 (KR) 10-2011-0083101

(51) Int. Cl. G09G 5/10

(52) U.S. Cl. 345/697

(57) ABSTRACT

A three-dimensional image display apparatus includes a backlight unit including light emitting blocks driven independently of each other, a display panel which emits first light including a first image information using a first image data during an N-th frame period and emits second light including a second image information using a second image data during an (N+1)-th frame period, where N is a natural number; and an active retarder including polarizing blocks sequentially scanned along a first direction, where the active retarder converts the first light into first polarized light during the N-th frame period and converts the second light into second polarized light during the (N+1)-th frame period, and where the light emitting blocks are sequentially turned off in a unit of at least one light emitting block in each of the N-th and (N+1)-th frame periods along a scanning direction of the polarizing blocks.

This application claims priority to Korean Patent Application No. 10-2011-0083101, filed on Aug. 19, 2011, and all the benefits accruing therefrom under U.S.C. §119, the content of which in its entirety is herein incorporated by reference.

### BACKGROUND

1. Field

Exemplary embodiments of the invention relates to a three-dimensional image display apparatus and a method of driving the three-dimensional image display apparatus.

2. Description of the Related Art

A three-dimensional (“3D”) image display apparatus typically provides a left-eye image and a right-eye image to a left eye and a right eye of an observer such that a binocular disparity occurs. The observer may perceive a 3D image using the binocular disparity based on the left- and right-eye images provided from the 3D image display apparatus through the two eyes thereof

In general, the 3D image display apparatus is classified into a glass type 3D image display apparatus and a non-glass type 3D image display apparatus. The glass type 3D image display apparatus alternately displays the left-eye image and the right-eye image to display the 3D image using a polarizing glass.

However, the left-eye image and the right-eye image may be mixed with each other when the left-eye image is changed to the right-eye image or vice versa, and deterioration in display quality of the 3D image may thereby occur.

### SUMMARY

Exemplary embodiments of the invention provide a three-dimensional (“3D”) image display apparatus, where deterioration in display quality of a 3D image is effectively prevented.

Exemplary embodiments of the invention provide a method of driving the 3D image display apparatus.

According to an exemplary embodiment, a 3D image display apparatus includes: a backlight unit which generates light, where the backlight unit includes a plurality of light emitting blocks driven independently of each other; a display panel disposed on the backlight unit to receive the light, where the display panel emits first light including a first image information using a first image data during an N-th frame period and emits second light including a second image information using a second image data during an (N+1)-th frame period, where N is a natural number; and an active retarder including a plurality of polarizing blocks sequentially scanned along a first direction, where the active retarder converts the first light exiting from the display panel into first polarized light in response to a first driving voltage during the N-th frame period and converts the second light exiting from the display panel into second polarized light in response to a second driving voltage during the (N+1)-th frame period, and where the light emitting blocks are sequentially turned off in a unit of at least one light emitting block in each of the N-th and (N+1)-th frame periods along a scanning direction of the polarizing blocks.

According to an exemplary embodiment, a method of driving a 3D image display apparatus includes sequentially turning off a plurality of light emitting blocks, which generates light, in a unit of at least one light emitting block during each of an N-th frame period and an (N+1)-th frame period; emitting a first light including a first image information using a first image data during the N-th frame period based on the light and emitting a second light including a second image information using a second image data during the (N+1)-th frame period based on the light, wherein N is a natural number; and converting the first light into first polarized light in response to a first driving voltage applied to a plurality of polarizing blocks and during the N-th frame period and converting the second light into second polarized light in response to a second driving voltage during the (N+1)-th frame period applied to the polarizing blocks by sequentially scanning the polarizing blocks.

In exemplary embodiments, the 3D image display apparatus includes the backlight unit having the light emitting blocks driven independently of each other and the light emitting blocks are sequentially turned off in a unit of at least one light emitting block in each frame along a scanning direction of the polarizing blocks.

In exemplary embodiments, the light emitting block corresponding to the boundary between the first area, in which the left-eye image is displayed, and the second area, in which the right-eye image is displayed, are turned off such that the cross-talk phenomenon that may occur by interference between the left-eye image and the right-eye image is effectively prevented.

### BRIEF DESCRIPTION OF THE DRAWINGS

The above and other features and aspects of the invention will become readily apparent by reference to the following detailed description when considered in conjunction with the accompanying drawings wherein:

FIG. 1 is a block diagram showing an exemplary embodiment of a three-dimensional (“3D”) image display apparatus according to the invention;

FIG. 2 is a block diagram showing an exemplary embodiment of a display panel and a panel driver shown in FIG. 1;

FIG. 3 is a cross-sectional view of the 3D image display apparatus shown in FIG. 1;

FIG. 4 is a block diagram showing an exemplary embodiment of a scan pulse corresponding to an image displayed on the display panel;

FIG. 5 is a block diagram showing an operation of an exemplary embodiment of the 3D image display apparatus in a 3D mode;

FIG. 6 is a block diagram showing an exemplary embodiment of a scanning method of a backlight unit and an active retarder shown in FIG. 1;

FIG. 7 is a block diagram showing a turned-off block of an exemplary embodiment of the backlight unit during an N-th frame period;

FIG. 8 is a block diagram showing an alternative exemplary embodiment of a scanning method of a backlight unit and an active retarder according to the invention;

FIG. 9 is a block diagram showing another alternative exemplary embodiment of a scanning method of a backlight unit and an active retarder according to the invention;

FIG. 10 is a block diagram view showing an exemplary embodiment of a backlight unit according to the invention; and

FIG. 11 is a block diagram view showing an alternative exemplary embodiment of a backlight unit according to the invention.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments of the invention will be explained in detail with reference to the accompanying drawings.

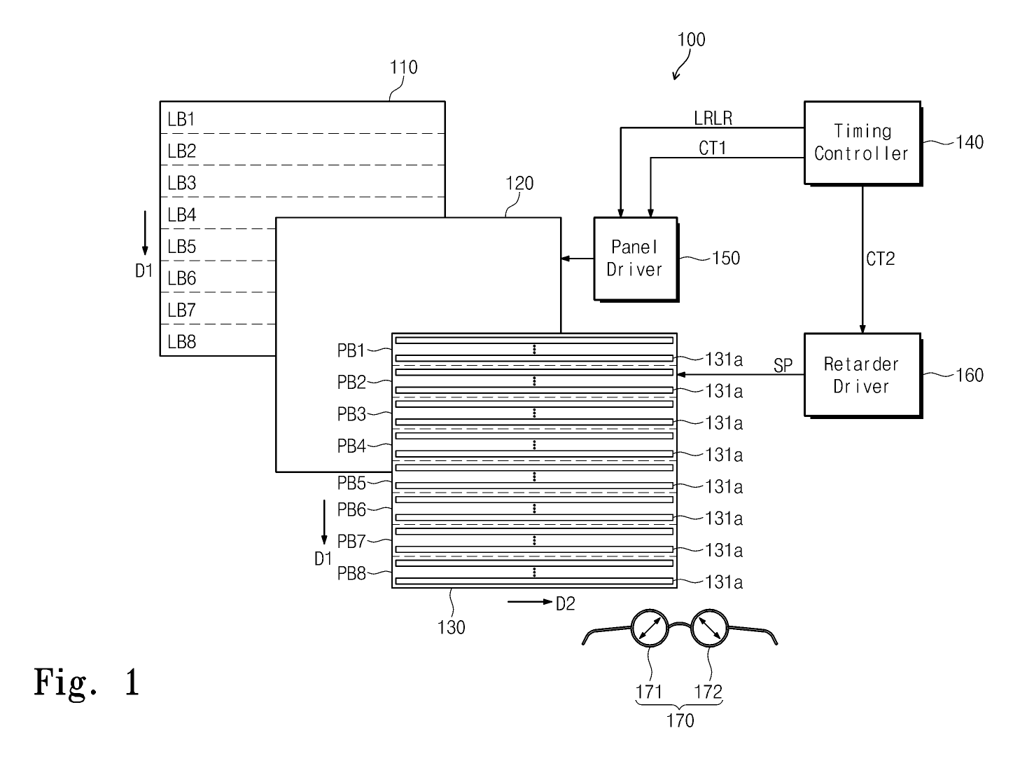

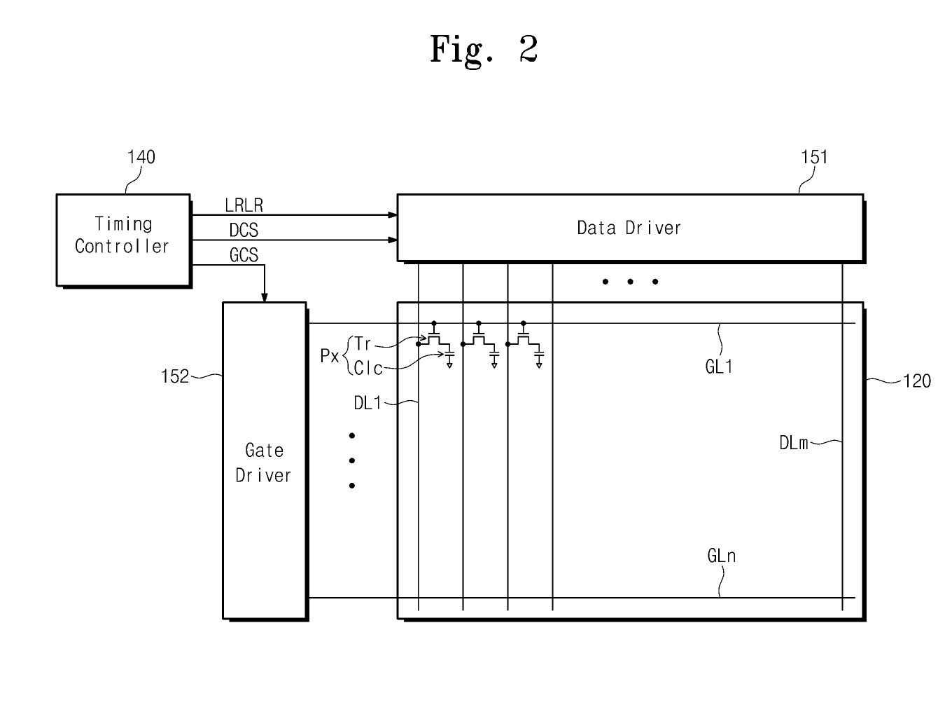

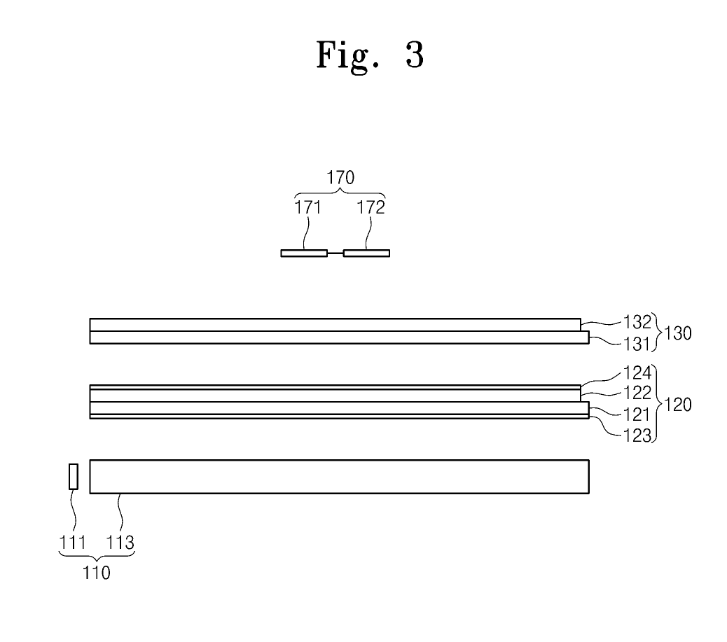

FIG. 1 is a block diagram showing an exemplary embodiment of a three-dimensional (“3D”) image display apparatus according to the invention, FIG. 2 is a block diagram showing an exemplary embodiment of a display panel and a panel driver shown in FIG. 1, and FIG. 3 is a cross-sectional view of the 3D image display apparatus shown in FIG. 1.

Referring to FIGS. 1 to 3, a 3D image display apparatus 100 includes a backlight unit 110, a display panel 120, an active retarder 130, a timing controller 140, a panel driver 150, a retarder driver 160 and polarizing glasses 170.

In an exemplary embodiment, the display panel 120 may be a liquid crystal display panel, a plasma display panel, or an electroluminescence (“EL”) device including an organic light emitting diode (“OLED”), for example, but not being limited thereto.

Hereinafter, for convenience of description, an exemplary embodiment where the display panel 120 is a liquid crystal display panel will be described, but the invention is not limited thereto.

The display panel 120 includes an array substrate 121, an opposite substrate 122 facing the array substrate 121, and a first liquid crystal layer (not shown) interposed between the array substrate 121 and the opposite substrate 122. The array substrate 121 includes a plurality of data lines DL1 to DLm, a plurality of gate lines GL1 to GLn, and a plurality of pixels Px. The data lines DL1 to DLm are insulated from the gate lines GL1 to GLn while crossing the gate lines GL1 to GLn.

The pixels Px are arranged on the array substrate 121 substantially in a matrix form. Each of the pixels Px includes a thin film transistor Tr and a liquid crystal capacitor Clc connected to the thin film transistor Tr. The thin film transistor Tr includes a gate electrode connected to a corresponding gate line of the gate lines GL1 to GLn, a source electrode connected to a corresponding data line of the data lines DL1 to DLm, and a drain electrode connected to the liquid crystal capacitor Clc.

In an exemplary embodiment, the liquid crystal capacitor Clc is collectively defined by a pixel electrode disposed on the array substrate 121, a common electrode disposed on the opposite 122 facing the pixel electrode, and a first liquid crystal layer interposed between the pixel electrode and the common electrode.

In an exemplary embodiment, the common electrode is disposed on the opposite substrate 122 based on a vertical electric field driving method, such as a twisted nematic (“TN”) mode and a vertical alignment (“VA”) mode, for example. In an alternative exemplary embodiment, the common electrode may be disposed on the array substrate 121 based on a horizontal electric field driving method, such as an in-plane switching mode and a fringe field switching mode, for example.

The display panel 120 includes a first polarizer 123 and a second polarizer 124, which are disposed on the array substrate 121 and the opposite substrate 122, respectively. In one exemplary embodiment, the first polarizer 123 and the second polarizer 124 are attached to outer surfaces of the array substrate 121 and the opposite substrate 122, respectively. The first polarizer 123 controls a polarization property of light incident to the array substrate 121 and the second polarizer 124 controls a polarization property of light incident to the active retarder 130. The first polarizer 123 may have a light absorbing axis substantially perpendicular to a light absorbing axis of the second polarizer 124.

In an exemplary embodiment, the display panel 120 may be a transmissive liquid crystal display panel, a transflective liquid crystal display panel, or a reflective liquid crystal display panel, for example, but not being limited thereto. In an exemplary embodiment, where the display panel 120 is the transmissive liquid crystal display panel or the transflective liquid crystal display panel, the 3D image display apparatus 100 includes the backlight unit 110, as shown in FIG. 1.

The backlight unit 110 generates light and provides the light to the display panel 120. The backlight unit 110 may include a plurality of light emitting blocks LB1 to LB8 driven of each other and sequentially arranged along a first direction D1. The light emitting blocks LB1 to LB8 may be sequentially turned off in a unit of at least one light emitting block.

The backlight unit 110 may be a direct-illumination type backlight unit or an edge-illumination type backlight unit. In an exemplary embodiment, the backlight unit 110 is the edge-illumination type backlight unit, as shown in FIG. 3. In such an embodiment, the backlight unit 110 includes a plurality of light sources 111 that emits the light and a light guide plate 113 disposed adjacent to one side of the light sources 111. The light guide plate 113 receives the light from the light sources 111 and guides the received light to the display panel 120.

Each of the light sources 111 may include a light emitting diode, and at least one light emitting diode corresponds to each of the light emitting blocks LB1 to LB8. In an exemplary embodiment, the light guide plate 113 may be divided into eight areas along the first direction D1, and the eight areas in the light guide plate 113 may be defined as the light emitting blocks LB1 to LB8, respectively.

The active retarder 130 includes a first transparent substrate 131 and a second transparent substrate 132, which face each other while interposing a second liquid crystal layer (not shown) therebetween. The second liquid crystal layer may include a TN mode liquid crystal material having a phase-retardation of 90 degrees or an electrically controlled birefringence (“ECB”) liquid crystal material. The first transparent substrate 131 includes a plurality of scan electrodes 131a disposed thereon and extending in a second direction D2, which is substantially perpendicular to the first direction D1. The scan electrodes 131a are electrically insulated from each other and arranged along the first direction D1.

Each of the scan electrodes 131a may correspond to a portion of the gate lines GL1 to GLn disposed on the display panel 120. In an exemplary embodiment, the scan electrodes 131a corresponds to the gate lines GL1 to GLn in a ratio of 1:K (K is a natural number equal to or greater than 2), that is, the number of the gate lines is equal to K times the number of the scan electrodes. In one exemplary embodiment, for example, where the number of the gate lines GL1 to GLn of the display panel 120 is 1080 and the number of the scan electrodes 131a of the active retarder 130 is 90, one scan electrode may correspond to twelve gate lines.

In an exemplary embodiment, the active retarder 130 may include a plurality of polarizing blocks PB1 to PB8, which operates independently of each other. In an exemplary embodiment, the polarizing blocks PB1 to PB8 includes at least one scan electrode 131a.

The second transparent substrate 132 includes a reference electrode disposed thereon facing the scan electrodes 131a. In an exemplary embodiment, the reference electrode may be applied with a voltage having a level substantially the same as a level of the common voltage applied to the common electrode of the display panel 120.

In such an embodiment, the active retarder 130 controls an amount of a phase retardation of the light exiting from the display panel 120 based on an electric field generated by the scan electrodes 131a and the reference electrode, and thereby controls the polarization of the light.

In an exemplary embodiment, the timing controller 140 provides an image data in a two-dimensional (“2D”) format to the panel driver 150 during a 2D mode and provides a left-eye and right-eye image data LRLR in a 3D format to the panel driver 150 during a 3D mode. In such an embodiment, the timing controller 140 applies a first control signal CT1 to the panel driver 150 and a second control signal CT2 to the retarder driver 160.

The timing controller 140 selects a mode between the 2D mode and the 3D mode in accordance with a selection of user provided through a user interface. The user interface may include various input devices, such as an on-screen display (“OSD”), a remote controller, a keyboard and a mouse, for example.

As shown in FIG. 2, the panel driver 150 includes a data driver 151 and a gate driver 152. In the 3D mode, the data driver 151 receives the left-eye and right-eye image data LRLR from the timing controller 140. In an exemplary embodiment, the left-eye and right-eye image data LRLR may be provided to the data driver 151 at a frame frequency of about 60 by p hertz (Hz) (p is a natural number equal to or greater than 2). In an exemplary embodiment, the left-eye and right-eye image data LRLR may be alternately provided to the data driver 151 during the 3D mode. In such an embodiment, the timing controller 140 multiplies the frame frequency of the input image by n times to increase the frequency of the control signal used to control an operation timing of the data driver 151.

The data driver 151 converts the left-eye and right-eye image data LRLR into an analog data voltage having a positive or negative polarity in response to a data control signal DCS included in the first control signal CT1, and provides the converted voltage to the data lines DL1 to DLm disposed on the display panel 120. The gate driver 152 sequentially applies a gate pulse to the gate lines GL1 to GLn disposed on the display panel 120 in response to a gate control GCS included in the first control signal CT1.

In an exemplary embodiment, the display panel 120 outputs first light including left-eye image information using the left-eye image data during an N-th frame period (N is a natural number). In such an embodiment, the display panel 120 outputs second light including right-eye image information using the right-eye image data during an (N+1)-th frame period, such that the left-eye image and the right-eye image may be alternately displayed on the display panel 120.

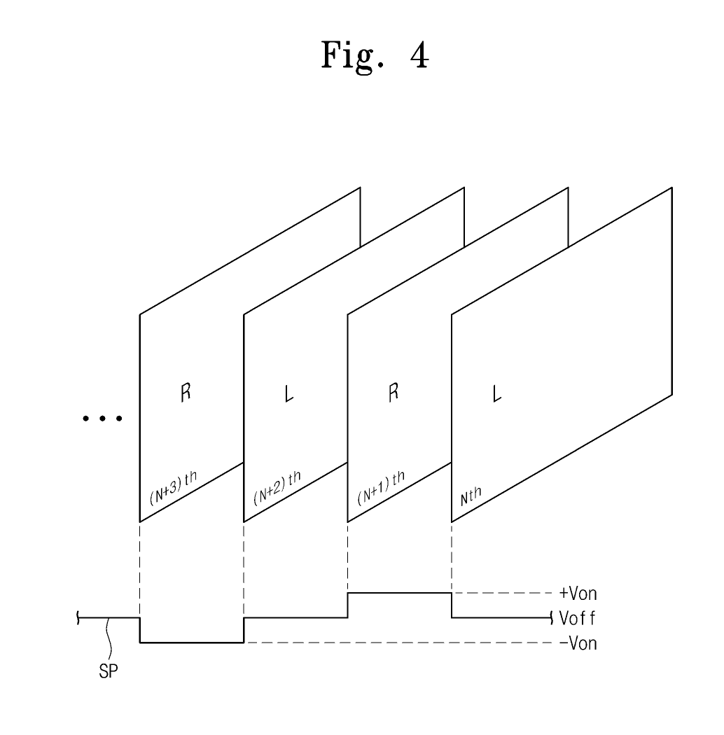

The retarder driver 160 applies a scan pulse SP to each of the scan electrodes 131a in response to the second control signal CT2. As shown in FIG. 4, the scan pulse SP may have an electric potential corresponding to an electric potential of a first driving voltage Voff or a second driving voltage Von based on the image displayed on the display panel 120.

FIG. 4 is a block diagram showing an exemplary embodiment of a scan pulse corresponding to an image displayed on the display panel.

Referring to FIGS. 1 and 4, the retarder driver 160 may apply the first driving voltage Voff, which has the same electric potential as the common voltage applied to the reference electrode, to the scan electrodes 131a when the left-eye image (or right-eye image) is displayed on the display panel 120. In an exemplary embodiment, the retarder driver 160 may apply the second driving voltage Von, which is different from the common voltage, to the scan electrodes 131a when the right-eye image (or left-eye image) is displayed on the display panel 120.

In an exemplary embodiment, the second driving voltage Von may have a positive polarity or a negative polarity with respect to the first driving voltage Voff to prevent the deterioration of the second liquid crystal layer disposed on the active retarder 130, and the positive second driving voltage+Von and the negative second driving voltage−Von may be alternately applied to the scan electrodes 131a.

In an exemplary embodiment, as shown in FIG. 4, the left-eye image has been displayed prior to the right-eye image, but not being limited thereto. In an alternative exemplary embodiment, the right-eye image is displayed prior to the left-eye image, and the driving voltage applied to the scan electrodes 131a may be different from the exemplary embodiment shown in FIG. 4.

Referring again to FIG. 1, in an exemplary embodiment where the active retarder 130 includes the polarizing blocks PB1 to PB8, the scan electrodes 131a included in a same polarizing block of the polarizing blocks PB1 to PB8 may be substantially simultaneously driven. In an exemplary embodiment, the electric potential of the scan pulse SP applied to the scan electrodes 131a included in each of the polarizing blocks PB1 to PB8 is sequentially varied in the first direction D1 based on the image displayed on the display panel 120. In an exemplary embodiment, when the right-eye image is displayed on the display panel 120 to correspond to each polarizing block PB1 to PB8, the scan electrodes 131a included in the corresponding polarizing blacks PB1 to PB8 may be applied with the first driving voltage Voff. In such an embodiment, when the left-eye image is displayed on the display panel 120 to correspond to each polarizing block PB1 to PB8, the scan electrodes 131a included in the corresponding polarizing blacks PB1 to PB8 may be applied with the second driving voltage Von.

In an exemplary embodiment, the active retarder 130 converts the first light from the display panel 120 into first polarized light in response to the first driving voltage Voff during the N-th frame period Nth and converts the second light from the display panel 120 into second polarized light in response to the second driving voltage Von during the (N+1)-th frame period (N+1)th.

In an exemplary embodiment, the polarizing glasses 170 include a left-eye polarizing filter 171 and a right-eye polarizing filter 172. In such an embodiment, a light absorbing axis of the right-eye polarizing filter 172 is different from a light absorbing axis of the left-eye polarizing filter 171, and the polarization property of the left-eye and the polarization property of the right eye are thereby different from each other.

The left-eye polarizing filter 171 transmits the first polarized light exiting from the active retarder 130, and the right-eye polarizing filter 172 transmits the second polarized light exiting from the active retarder 130.

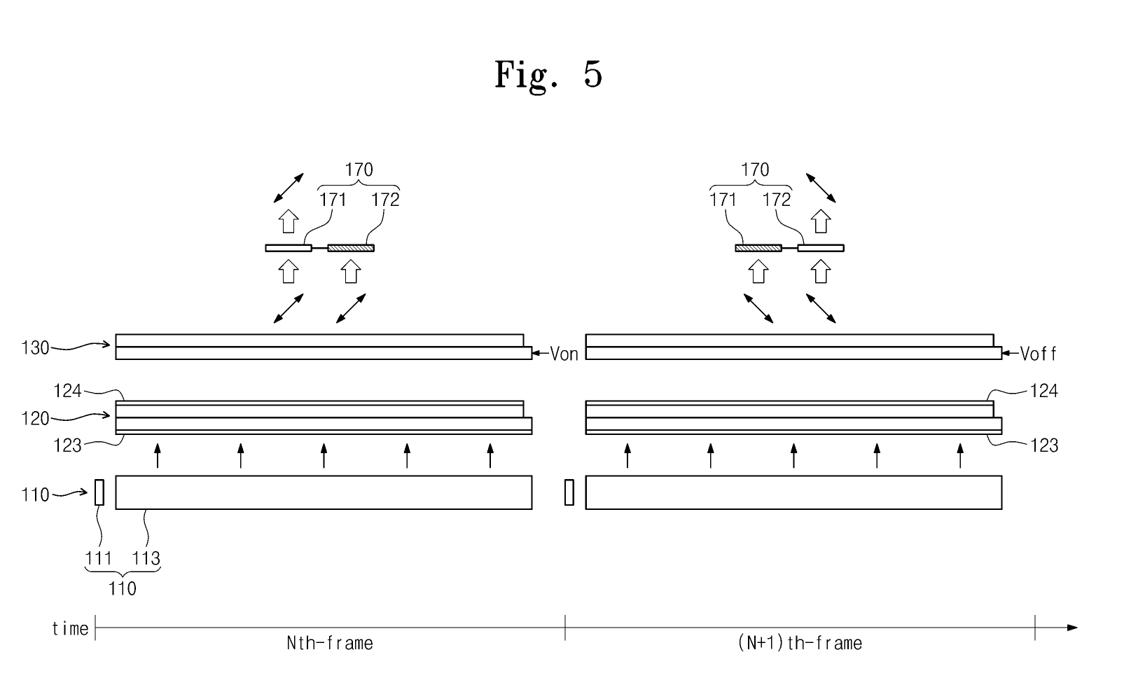

FIG. 5 is a block diagram showing an operation of an exemplary embodiment of the 3D image display apparatus in a 3D mode. FIG. 5 shows the left-eye and right-eye images transmitted through the display panel 120 and the active retarder 130 and provided to the polarizing glasses 170 in each of the N-th and (N+1)-th frames.

In the 3D mode, the display panel 120 alternately displays the left-eye image and the right-eye image in a unit of one frame.

In an exemplary embodiment, during the N-th frame, the display panel 120 polarizes the first light including the left-eye image information using the second polarizer 124, and outputs left-polarized first light. In such an embodiment, when the first driving voltage Voff is applied to the scan electrodes 131a (shown in FIG. 1) during the N-th frame, the active retarder 130 retards the phase of the left-polarized first light, by about 90 degrees and outputs the first polarized light, which is right-polarized such that the first polarized light exiting from the active retarder 130 transmits through the left-eye polarizing filter 171 of the polarizing glasses 170.

In an exemplary embodiment, during the (N+1)-th frame, the display panel 120 polarizes the second light including the right-eye image information using the second polarizer 124 and outputs left-polarized second light. In such an embodiment, when the second driving voltage Von is applied to the scan electrodes 131a during the (N+1)-th frame, the active retarder 130 outputs the second polarized light, which is left-polarized, without retarding the phase of the left-polarized second light from the display panel 120 such that the second polarized light from the active retarder 130 transmits through the right-eye polarizing filter 172 of the polarizing glasses 170.

In an exemplary embodiment, as described above, when the user wears the polarizing glasses 170, the left-eye image is transmitted to the left eye of the user during the N-th frame, and the right-eye image is transmitted to the right eye of the user during the (N+1)-th frame. In such an embodiment, the left-polarized light has a light axis crossing a light axis of a right-polarized light. In such an embodiment, the left-polarized light may be vertical linearly polarized light, and the right-polarized light may be horizontal linearly polarized light. In an exemplary embodiment, the right-polarized light may be vertical linearly polarized light, and the left-polarized light may be horizontal linearly polarized light. In an alternative exemplary embodiment, the left-polarized light may be left circularly polarized light, and the right-polarized light may be right circularly polarized light. In another alternative exemplary embodiment, the right-polarized light may be left circularly polarized light, and the left-polarized light may be right circularly polarized light.

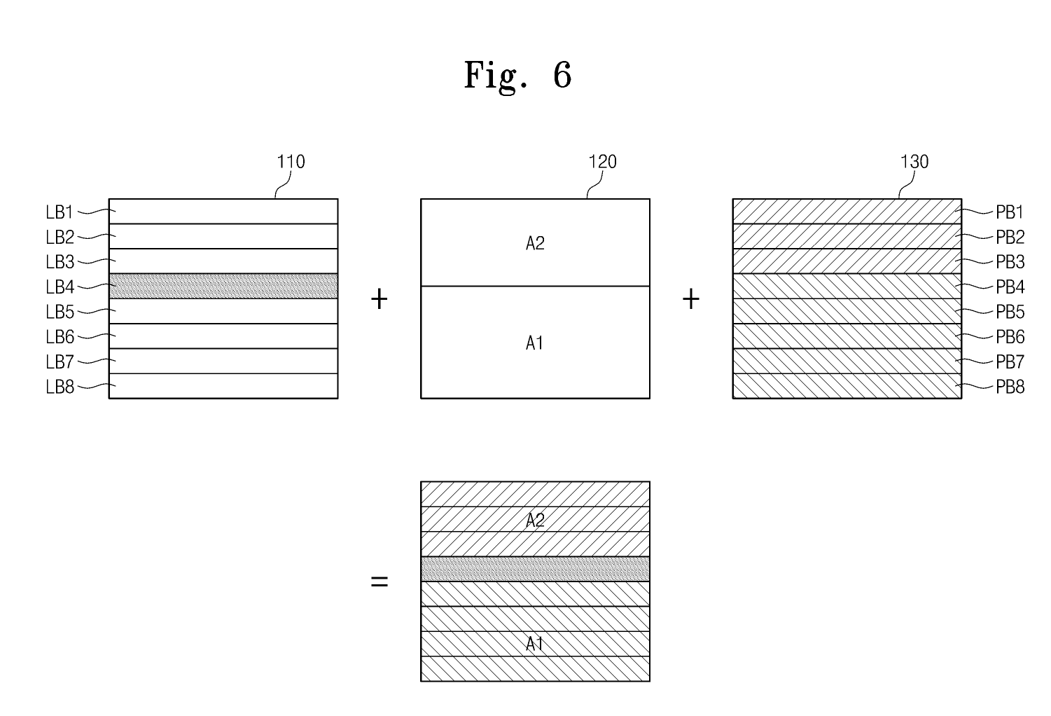

FIG. 6 is a block diagram showing an exemplary embodiment of a scanning method of a backlight unit and an active retarder shown in FIG. 1.

Referring to FIG. 6, the backlight unit 110 includes the light emitting blocks LB1 to LB8 driven independently of each other and sequentially arranged along the first direction D1. The light emitting blocks LB1 to LB8 may be sequentially turned off on a unit block by unit block basis, in which the unit block includes at least one light emitting block. FIG. 6 shows the light emitting blocks LB1 to LB8, in which a fourth light emitting block LB4 is turned off.

In the 3D mode, the left-eye image data is sequentially written in liquid crystal cells in a unit of one pixel row of the display panel 120 during the N-th frame period, and the right-eye image data is sequentially written in the liquid crystal cells of the display panel 120 on a pixel row by pixel row basis during the (N+1)-th frame period. In an exemplary embodiment, the liquid crystal cells maintains a state corresponding to the right-eye image data (or the left-eye image data) written during a previous frame period until the left-eye image data (or the right-eye image data) of a frame period is written therein. In an exemplary embodiment, the display panel 120 may include a first area A1 on which an image corresponding to the left-eye image data is displayed and a second area A2 on which an image corresponding to the right-eye image data is displayed. The turned-off fourth light emitting block LB4 may be a boundary between the first area A1 and the second area A2.

In an exemplary embodiment, the active retarder 130 includes the polarizing blocks PB1 to PB8 that is in a one-to-one correspondence with the light emitting blocks LB1 to LB8. In an exemplary embodiment, as shown in FIG. 6, fourth to eighth polarizing blocks PB4, PB5, PB6, PB7 and PB8 corresponding to the first area A1 retards the phase of the first light including the left-eye image information to convert the first light into the first polarized light, and first to third polarizing blocks PB1, PB2 and PB3 corresponding to the second area A2 outputs the second polarized light without retarding the phase of the second light including the right-eye image information.

In such an embodiment, the boundary between the first area A1 and the second area A2 may be corresponding to (e.g., disposed in) the fourth polarizing block PB4 of the polarizing blocks PB1 to PB8. As shown in FIG. 6, the polarizing blocks in an upper portion of the fourth polarizing block PB4 corresponds to the first area A1, and the polarizing blocks in a lower portion of the fourth polarizing block PB4 corresponds to the second area A2, while the fourth polarizing block PB4 may correspond to both the first area A1 and the second area A1 such that the fourth polarizing block PB4 retards the phase of the first light including the left-eye image information to convert the first light into the first polarized light.

When a polarization may occur by a portion of the fourth polarizing block PB4 corresponding to the second area A2. In an exemplary embodiment, the fourth light emitting block LB4 of the backlight unit 110, which corresponds to the fourth polarizing block PB4, is turned off such that the polarization are effectively prevented from being perceived.

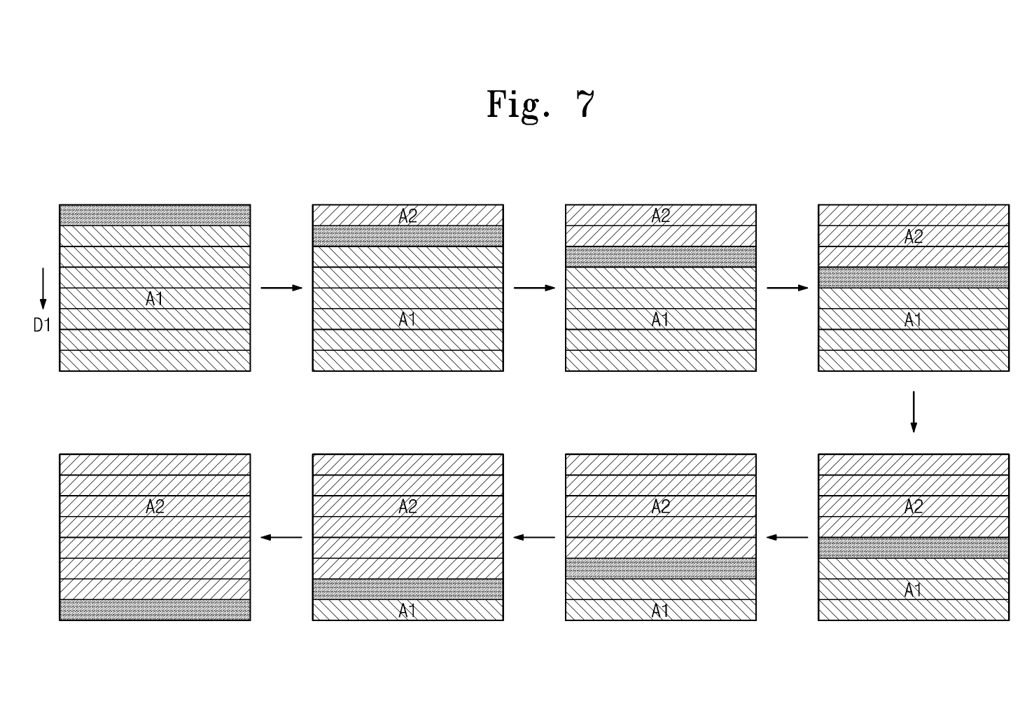

FIG. 7 is a block diagram showing a turned-off block of an exemplary embodiment of the backlight unit during an N-th frame period.

Referring to FIG. 7, when the (N+1)-th frame period starts, the right-eye image data is sequentially written in the display panel 120 on a pixel row by pixel row basis. When a predetermined time period lapses after the start of the (N+1)-th frame period, the display panel 120 may be divided into the first area A1, in which the left-eye image data is written, and the second area A2, in which the right-eye image data is written. In an exemplary embodiment, where the boundary between the first area A1 and the second area A2 is positioned in the first polarizing block PB1, the first light emitting block LB1 of the backlight unit 110, which corresponds to the first polarizing block PB1, may be turned off.

Then, when the boundary between the first area A1 and the second area A2 of the display panel 120 is positioned in the second polarizing block PB2, the second light emitting block LB2 of the backlight unit 110, which corresponds to the second polarizing block PB2, may be turned off.

In such an embodiment, the boundary between the first and second areas A1 and A2 of the display panel 120 moves downwardly along the first direction D1, and one light emitting block of the light emitting blocks LB1 to LB8 is thereby sequentially turned off during the (N+1)-th frame period.

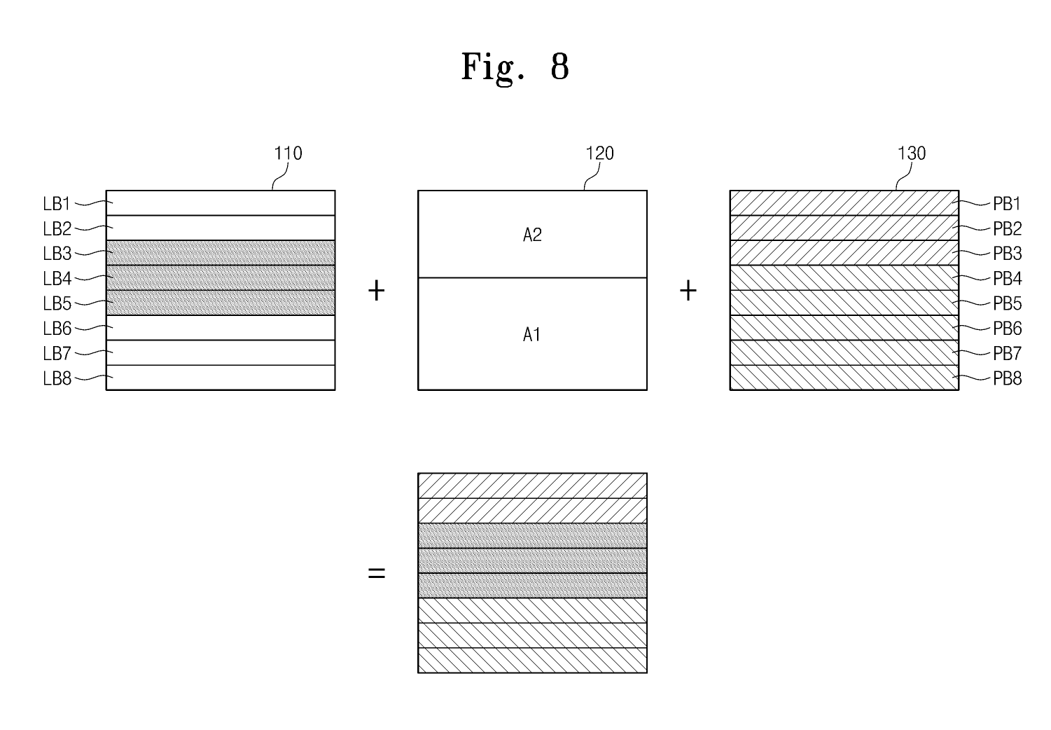

FIG. 8 is a block diagram showing an alternative exemplary embodiment of a scanning method of a backlight unit and an active retarder according to the invention.

Referring to FIG. 8, the backlight unit 110 includes the light emitting blocks LB1 to LB8 driven independently of each other and sequentially arranged along the first direction D1. In the illustrated embodiment, three adjacent light emitting blocks of the light emitting blocks LB1 to LB8 are sequentially turned off. In FIG. 8, third, fourth, and fifth light emitting blocks LB3, LB4 and LB5 of the light emitting blocks LB1 to LB8 are turned off.

The active retarder 130 may include the polarizing blocks PB1 to PB8 that is in a one-to-one correspondence with the light emitting blocks LB1 to LB8. In such an embodiment, the boundary between the first area A1 and the second area A2 may be in the fourth polarizing block PB4 of the polarizing blocks PB1 to PB8.

In an exemplary embodiment, where the light emitting blocks LB1 to LB8 is in one-to-one correspondence with the polarizing blocks PB1 to PB8, at least one light emitting block (e.g., three light emitting blocks as shown in FIG. 7) may be substantially simultaneously turned off. In such an embodiment, however, the turned-off light emitting blocks of the backlight unit 110 may be shifted by one light emitting block.

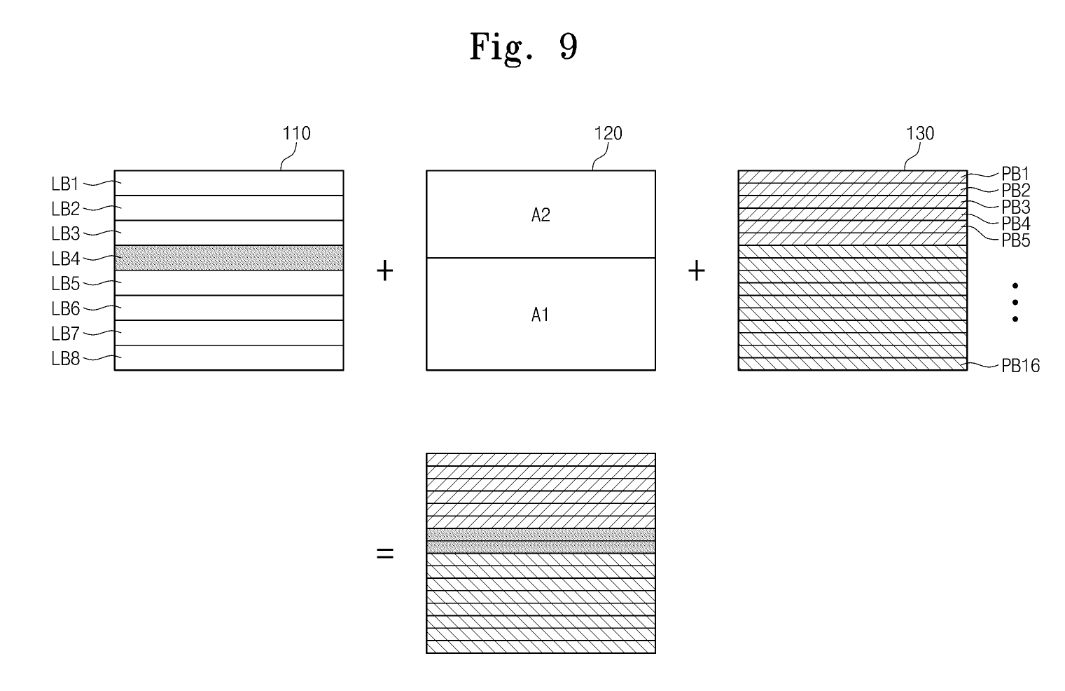

FIG. 9 is a block diagram showing another alternative exemplary embodiment of a scanning method of a backlight unit and an active retarder according to the invention.

Referring to FIG. 9, the backlight unit 110 includes the light emitting blocks LB1 to LB8 driven independently of each other and sequentially arranged along the first direction D1. In the illustrated exemplary embodiment, one of the light emitting blocks LB1 to LB8 are sequentially turned off

In such an embodiment, the active retarder 130 may include 16 polarizing blocks PB1 to PB16, which is two times larger the number of the polarizing blocks LB1 to LB8 shown in FIGS. 6 and 8. In such an embodiment, each of the light emitting blocks LB1 to LB8 corresponds two polarizing blocks of the polarizing blocks PB1 to PB 16.

In an exemplary embodiment, the boundary between the first area A1 and the second area A2 may correspond to a sixth polarizing block PB6 of the polarizing blocks PB1 to PB 16. The sixth polarizing block PB6 corresponds to the fourth light emitting block LB4 of the light emitting blocks LB1 to LB8, and thus the fourth light emitting block LB4 may be turned off.

In an exemplary embodiment, the light emitting block corresponding to the boundary between the first area A1 and the second area A2 is turned off, and the light polarization in the boundary between the first area A1 and the second area A2 is thereby prevented from being perceived to the user such that a cross-talk phenomenon is effectively prevented.

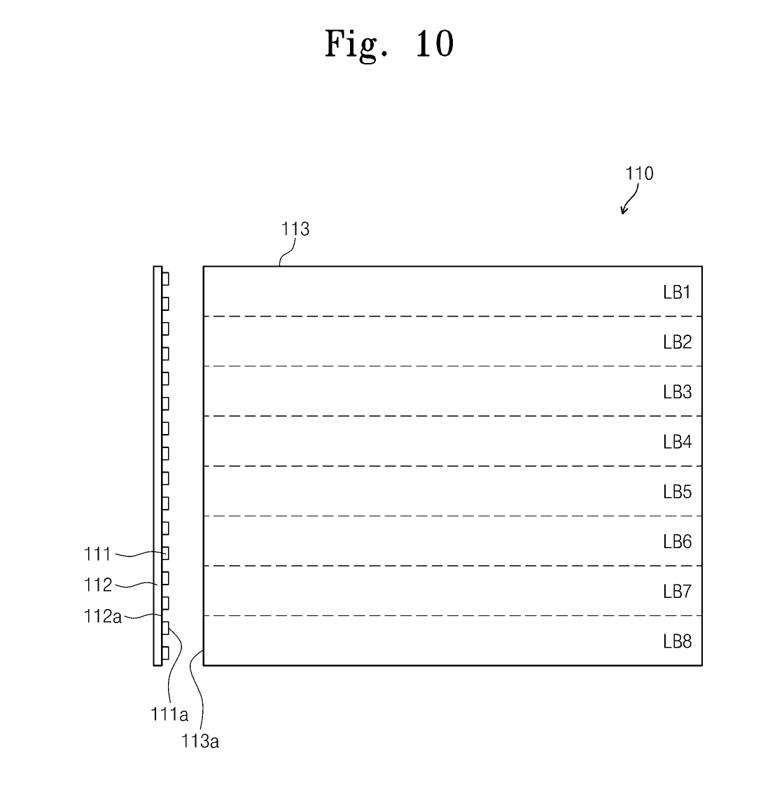

FIG. 10 is a block diagram view showing an exemplary embodiment of a backlight unit according to the invention.

Referring to FIG. 10, a backlight unit 110 includes a plurality of light sources 111, a light guide plate 113 and a printed circuit board 112.

The light guide plate 113 has a rectangular plate shape. In such an embodiment, the light guide plate 113 receives the light through a side surface 113a adjacent to the light sources 111 and guides the received light to the display panel 120 (shown in FIG. 2).

The printed circuit board 112 has a structure extending in a predetermined direction. The light guide plate 113 includes the light emitting blocks LB1 to LB8 arranged along the longitudinal direction of the printed circuit board 112.

Each of the light sources 111 includes a light emitting diode. The light sources 111 are disposed on a first surface 112a of the printed circuit board 112 and arranged along the longitudinal direction of the printed circuit board 112.

At least one light source of the light sources 111 is disposed corresponding to each of the light emitting blocks LB1 to LB8. The light emitting blocks LB1 to LB8 may be sequentially turned off in a unit of one light emitting block along the first direction D1 by sequentially turning off the light sources 111 corresponding thereto in the first direction D1.

In an exemplary embodiment, each of the light sources 111 includes a light exit surface 111a from which the light exits. In such an embodiment, the light exit surface 111a may be substantially parallel to the first surface 112a of the printed circuit board 112. In such an embodiment, the light exit surface 111a of the light sources 111 and the first surface 112a of the printed circuit board 112 may be substantially parallel to the side surface 113a of the light guide plate 113.

In an exemplary embodiment, as shown in FIG. 10, the backlight unit 110 including the light sources 111 disposed adjacent to the side surface 113a of the light guide plate 113, but the invention is not limited thereto. In an alternative exemplary embodiment, the light sources 111 of the backlight unit 110 may be disposed adjacent to each of at least two side surfaces of the light guide plate 113.

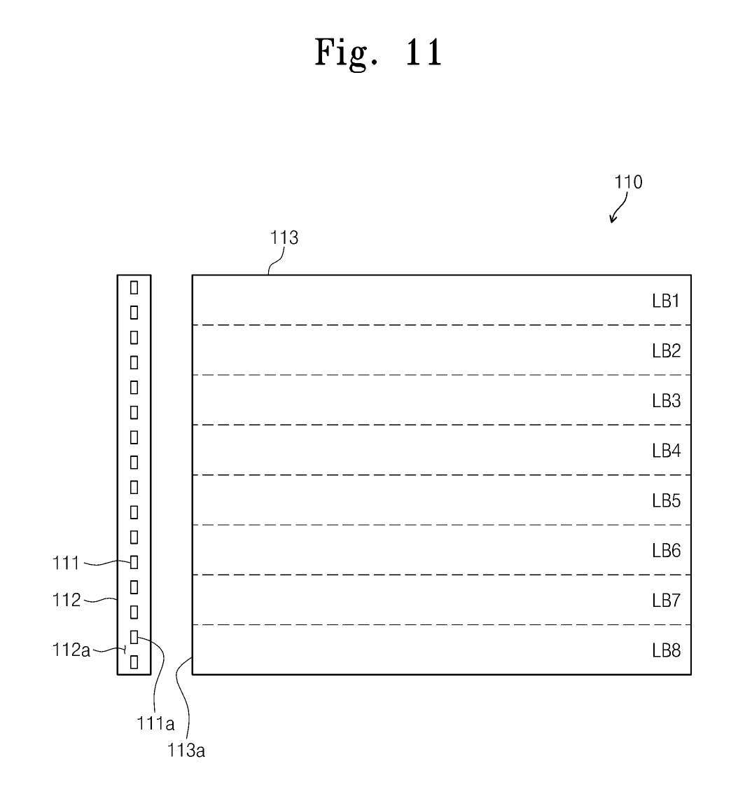

FIG. 11 is a block diagram showing an alternative exemplary embodiment of a backlight unit according to the invention.

Referring to FIG. 11, each of the light sources 111 includes the light exit surface 111a from which the light exits. In such an embodiment, the light exit surface 111a may be substantially vertical to the first surface 112a of the printed circuit board 112. In such an embodiment, the light exit surface 111a of the light sources 111 and the first surface 112a of the printed circuit board 112 may be substantially parallel to the side surface 113a of the light guide plate 113.

Although the exemplary embodiments of the invention have been described, it is understood that the invention should not be limited to these exemplary embodiments but various changes and modifications may be made by one ordinary skilled in the art within the spirit and scope of the invention as hereinafter claimed.

What is claimed is:

1. A three-dimensional image display apparatus comprising:
a backlight unit which generates light, wherein the backlight unit comprises a plurality of light emitting blocks driven independently of each other;
a display panel disposed on the backlight unit to receive the light, wherein the display panel emits first light including a first image information using a first image data during an N-th frame period and emits second light including a second image information using a second image data during an (N+1)-th frame period, wherein N is a natural number; and
an active retarder comprising a plurality of polarizing blocks sequentially scanned along a first direction, wherein the active retarder converts the first light exiting from the display panel into first polarized light in response to a first driving voltage during the N-th frame period and converts the second light exiting from the display panel into second polarized light in response to a second driving voltage during the (N+1)-th frame period,
wherein the light emitting blocks are sequentially turned off in a unit of at least one light emitting block in each of the N-th and (N+1)-th frame periods along a scanning direction of the polarizing blocks.

2. The three-dimensional image display apparatus of claim 1, wherein
the display panel includes a first area, from which the first light exits, and a second area, from which the second light exits, and
a light emitting block of the light emitting blocks is turned off when the light emitting bock corresponds to a boundary between the first area and the second area.

3. The three-dimensional image display apparatus of claim 2, wherein the light emitting blocks and the polarizing blocks are in a one-to-one correspondence.

4. The three-dimensional image display apparatus of claim 3, wherein the light emitting blocks are sequentially turned off in a unit of one light emitting block.

5. The three-dimensional image display apparatus of claim 2, wherein the number of the light emitting blocks is equal to n times the number of the polarizing blocks, wherein n is a natural number.

6. The three-dimensional image display apparatus of claim 5, wherein
the light emitting blocks are sequentially turned off in a unit of at least two light emitting blocks, and
an area of the turned-off light emitting blocks is shifted by one light emitting block.

7. The three-dimensional image display apparatus of claim 1, wherein
the active retarder comprises a plurality of scan electrodes arranged along the first direction, and
the polarizing blocks are sequentially scanned by a scan pulse applied to the scan electrodes.

8. The three-dimensional image display apparatus of claim 7, wherein
the display panel comprises a plurality of gate lines arranged substantially parallel to the scan electrodes, and
the number of the gate lines is equal to K times the number of the scan electrodes, wherein K is a natural number equal to or larger than 2.

9. The three-dimensional image display apparatus of claim 8, further comprising:
a panel driver which sequentially applies a gate signal to the gate lines to control a scan timing of the gate lines; and
a retarder driver which applies the first driving voltage and the second driving voltage to the scan electrodes to control the scan timing of the scan electrodes.

10. The three-dimensional image display apparatus of claim 9, wherein the scan pulse applied to each of the scan electrodes has an electric potential varied in a unit of one frame period.

11. The three-dimensional image display apparatus of claim 1, further comprising:
polarizing glasses which receive the first polarized light and the second polarized light from the active retarder,
wherein the polarizing glasses comprises:
a first polarizing filter which transmits the first polarized light; and
a second polarizing filter which transmits the second polarized light.

12. The three-dimensional image display apparatus of claim 11, wherein the display panel comprises:
a first polarizer which polarizes the light generated from the backlight unit; and
a second polarizer which polarizes light passing exiting to the active retarder after passing therethrough.

13. The three-dimensional image display apparatus of claim 1, wherein the backlight unit comprises:
a plurality of light sources which emits the light; and
a light guide plate which receives the light from the light sources through at least one side surface thereof to guide the light to the display panel.

14. The three-dimensional image display apparatus of claim 13, wherein the light sources are sequentially arranged along the first direction.

15. The three-dimensional image display apparatus of claim 1, wherein
the first image data is a left-eye image data applied to the display panel, and
the second image data is a right-eye image data applied to the display panel.

16. A method of driving a three-dimensional image display apparatus, the method comprising:
sequentially turning off a plurality of light emitting blocks, which generates light, in a unit of at least one light emitting block during each of an N-th frame period and an (N+1)-th frame period;
emitting a first light including a first image information using a first image data during the N-th frame period based on the light and emitting a second light including a second image information using a second image data during the (N+1)-th frame period based on the light, wherein N is a natural number; and
converting the first light into first polarized light in response to a first driving voltage applied to a plurality of polarizing blocks and during the N-th frame period and converting the second light into second polarized light in response to a second driving voltage during the (N+1)-th frame period applied to the polarizing blocks by sequentially scanning the polarizing blocks.

17. The method of claim 16, wherein the light emitting blocks are sequentially turned off along a direction, in which the polarizing blocks are scanned.

18. The method of claim 17, wherein
the light emitting blocks and the polarizing blocks are in a one-to-one correspondence, and
the light emitting blocks are sequentially turned off in a unit of one light emitting block.

19. The method of claim 16, wherein
the first image data is a left-eye image data, and
the second image data is a right-eye image data.
